(19) United States
(12) Patent Application Publication
(10) Pub. No.: US 2016/0121513 A1
(43) Pub. Date: May 5, 2016

(54) Lower Blade Guard for a Circular Saw

(71) Applicants: Robert Bosch Tool Corporation, Broadview, IL (US); Robert Bosch GmbH, Stuttgart (DE)

(72) Inventor: Douglas Mahoney, Chicago, IL (US)

(21) Appl. No.: 14/926,080

(22) Filed: Oct. 29, 2015

Related U.S. Application Data
(60) Provisional application No. 62/072,745, filed on Oct. 30, 2014.

(51) Int. Cl. B27G 19/04; B23D 45/16; B27B 9/04

(52) U.S. Cl. CPC B27G 19/04; B27B 9/04; B23D 45/16

(57) ABSTRACT

A circular saw includes a motor, a blade axle operably connected to the motor and configured to support a blade, and a footplate configured to support the motor above a workpiece at a reference position in which the blade is positioned with zero bevel. The circular saw further includes a blade guard that is rotatable about the axis of rotation from a closed position to an open position and includes an anti-snag structure with a front end portion and a trailing edge portion. The anti-snag structure includes a linear leading edge located between the front end portion and the trailing edge portion, and is configured such that when the footplate is at the reference position and the blade guard is in the closed position, a line extending through the axis of rotation and perpendicular to the footplate when viewed from a side elevational view passes through the linear leading edge.

This application claims the benefit of priority of U.S. provisional application Ser. No. 62/072,745, filed on Oct. 30, 2014, the disclosure of which is herein incorporated by reference in its entirety.

### TECHNICAL FIELD

The disclosure generally relates to power hand tools, and more particularly to portable circular saws.

### BACKGROUND

Portable circular saws are in widespread use for cutting workpieces such as lumber, vinyl siding, and many other materials. Circular saws generally include a rotary blade assembly and a motorized drive unit disposed within a housing, a handle disposed on the housing, and a base or footplate that contacts a workpiece during cutting operations. An upper blade guard and a moveable lower blade guard typically cover the entire periphery of the blade except for a small front portion of the blade that is configured to make initial contact with a workpiece to be cut.

The lower blade guard is biased toward a closed position around a lower part of the saw blade by a tension or torsion spring. As a user advances the saw forward to make a cut, the workpiece contacts a front edge of the lower blade guard, causing the lower blade guard to rotate toward an open position by creating a moment opposite of and greater than that of the tension or torsion spring.

The typical circular saw lower blade guard is subject to snagging on a workpiece during certain types of cuts. Known lower blade guards include an outer wall covering only a small portion of the blade in a radial direction, about 20% of the radius in some instances. The radial gap between the lower blade guard and the footplate enables thin sections of thin materials to bypass the leading edge of the outer wall and to jam or “snag” on a more rearward edge of the outer wall. When the thin section snags against the rearward edge of the outer wall, the circular saw cannot be moved forward through the workpiece and the lower blade guard is prevented from rotating any further toward the open position. To resolve a snag, the user must manually rotate the lower blade guard toward the open position. The need to manually rotate the lower blade guard is inconvenient for the operator of the circular saw.

As shown in FIG. 1, a lower blade guard 1 has been developed that reduces the tendency of the guard to snag on a workpiece during some types of cuts. The lower blade guard 1 includes an anti-snag wall portion including a curved leading edge 5 and a rear edge 7. The curved leading edge 5 extends from a front end 4 to a corner 6. The rear edge 7 extends from the corner 6 to a rear end 8. The lower blade guard 1 includes a mounting ring 11 for pivotally mounting the lower blade guard 1 to a circular saw.

With reference to FIG. 2, when the lower blade guard 1 is mounted on a circular saw 2 and is pivoted to the closed position (as shown in FIG. 2), the curved leading edge 5 is positioned completely in front of a centerline C1, such that the centerline C1 passes through no portion of the curved leading edge 5. The centerline C1 extends perpendicularly to a footplate 9 of the circular saw 2 and is aligned with a center of the mounting ring 11 as viewed from a side elevational view, as shown in FIG. 2. Moreover, the corner 6 is even with the footplate 9, such that the centerline C1 passes through no portion of the corner 6. Accordingly, there is no gap between the footplate 9 and the anti-snag wall portion 3 into which thin pieces of a workpiece may enter and snag the lower blade guard 1.

Despite its benefits, the lower blade guard 1 still results in snagging during some certain types of cuts, particularly during combination cuts. Combination cuts are cuts in which the blade is both beveled and mitered. When making a bevel cut, a cutting plane of the saw blade and a plane defined by the bottom surface of the footplate define an angle other than ninety degrees. When making a miter cut, the cutting plane of the saw blade defines an angle other than ninety degrees with a leading edge or surface of the workpiece piece. Combination cuts requiring a steep bevel angle and a steep miter angle may result in the workpiece contacting the anti-snag wall portion 3 at an angle that binds the lower blade guard 1 and prevents the lower blade guard 1 from pivoting toward the open position as the user attempts to advance the saw through the workpiece. This type of combination cut is regularly encountered by users in roofing applications.

Safety guidelines limit the blade exposure angle, which is the amount of blade periphery exposed when the lower blade guard 1 is in the closed position. Therefore, the problems described above cannot be overcome by minimizing the size of the lower blade guard. As a result, there is a need for a circular saw including a lower blade guard that addresses at least some of the above-described issues.

### SUMMARY

According to an exemplary embodiment of the disclosure, a circular saw includes a motor, a blade axle, a footplate, and a blade guard. The blade axle is operably connected to the motor and is configured to support a circular saw blade. The blade axle defines an axis of rotation. The footplate is configured to support the motor above a workpiece at a reference position. The saw blade is positioned with zero bevel angle relative to the workpiece when the motor is in the reference position. The blade guard is rotatable about the axis of rotation from a closed position to an open position. The blade guard includes an anti-snag structure with a front end portion and a trailing edge portion. The anti-snag structure includes a linear leading edge located between the front end portion and the trailing edge portion. The anti-snag structure is configured such that when the footplate is at the reference position and the blade guard is in the closed position, a line extending through the axis of rotation and perpendicular to the footplate when viewed from a side elevational view passes through the linear leading edge.

According to another exemplary embodiment of the disclosure, a circular saw includes a housing, a motor supported by the housing, a blade axle, a footplate, and a blade guard. The blade axle is operably connected to the motor and is configured to support a circular saw blade. The blade axle defines an axis of rotation. The footplate is configured to support the housing and defines a workpiece support surface. The footplate is positionable relative to housing in a reference position in which the saw blade defines zero bevel angle relative to the workpiece support surface. The blade guard is rotatable about the axis of rotation from a closed position to an open position. The blade guard includes an anti-snag structure with a front end portion and a trailing edge portion. The anti-snag structure includes a linear leading edge located between the front end portion and the trailing edge portion. The anti-snag structure is configured such that when the footplate is at the reference position and the blade guard is in the closed position, a line extending through the axis of rotation and perpendicular to the footplate when viewed from a side elevational view passes through the linear leading edge.

### BRIEF DESCRIPTION OF THE DRAWINGS

The above-described features and advantages, as well as others, should become more readily apparent to those of ordinary skill in the art by reference to the following detailed description and the accompanying figures in which:

FIG. 1 shows an elevational view of a lower blade guard according to the prior art;

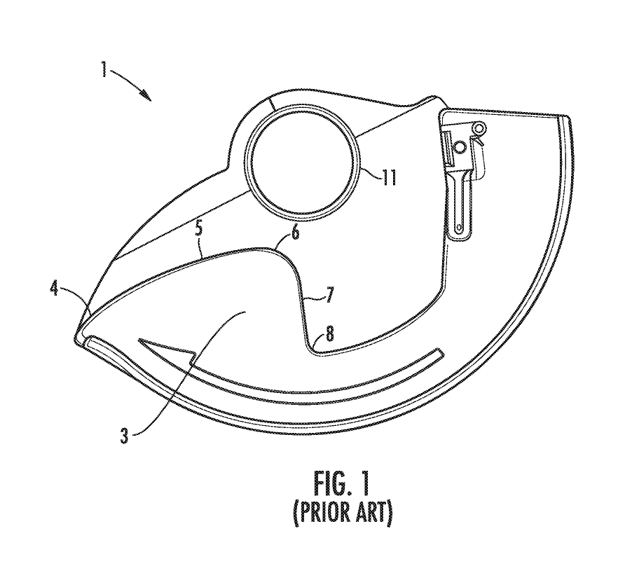

FIG. 2 shows an elevational view of a prior art circular saw including the prior art lower blade guard of FIG. 1;

FIG. 3 shows a perspective view of an exemplary circular saw, according to the disclosure, including a lower blade guard with an improved anti-snag structure;

FIG. 4A shows an elevational view of the circular saw of FIG. 3 with the lower blade guard in a closed position;

FIG. 4B shows an elevational view of the circular saw of FIG. 3 with the lower blade guard in an open position;

FIG. 5 shows a perspective view of the lower blade guard of the circular saw of FIG. 3;

FIG. 6 shows an elevational view of the lower blade guard of the circular saw of FIG. 3;

FIG. 7 shows a perspective view of yet another exemplary circular saw, according to the disclosure, including a lower blade guard with an improved anti-snag structure; and

FIG. 8 shows an elevational view of the circular saw of FIG. 7.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that this disclosure includes any alterations and modifications to the illustrated embodiments and includes further applications of the principles of the disclosure as would normally occur to one skilled in the art to which this disclosure pertains.

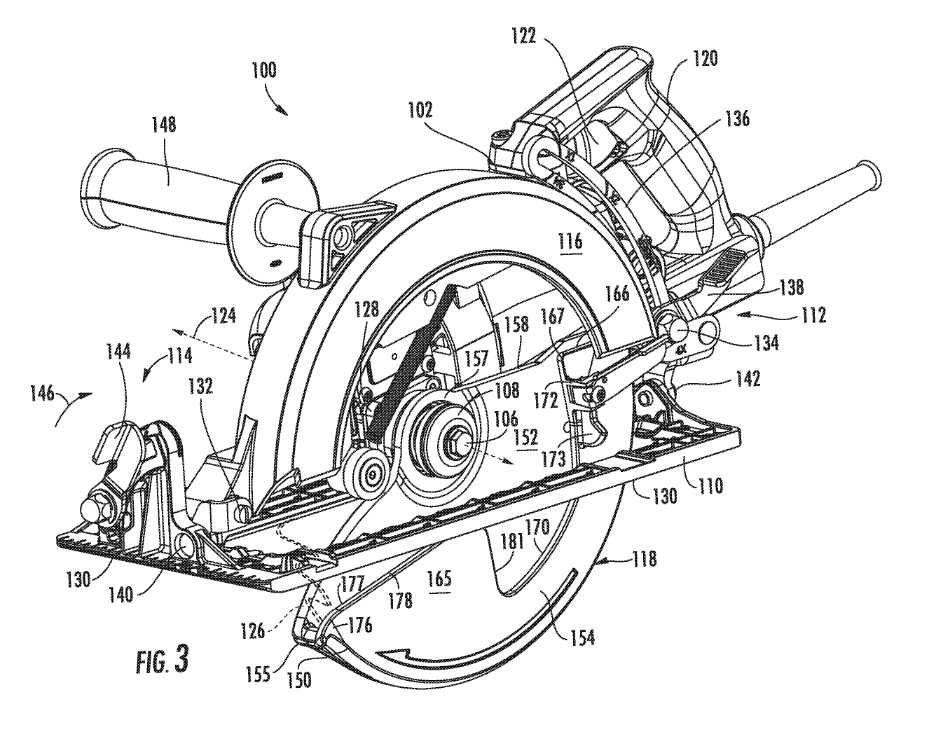

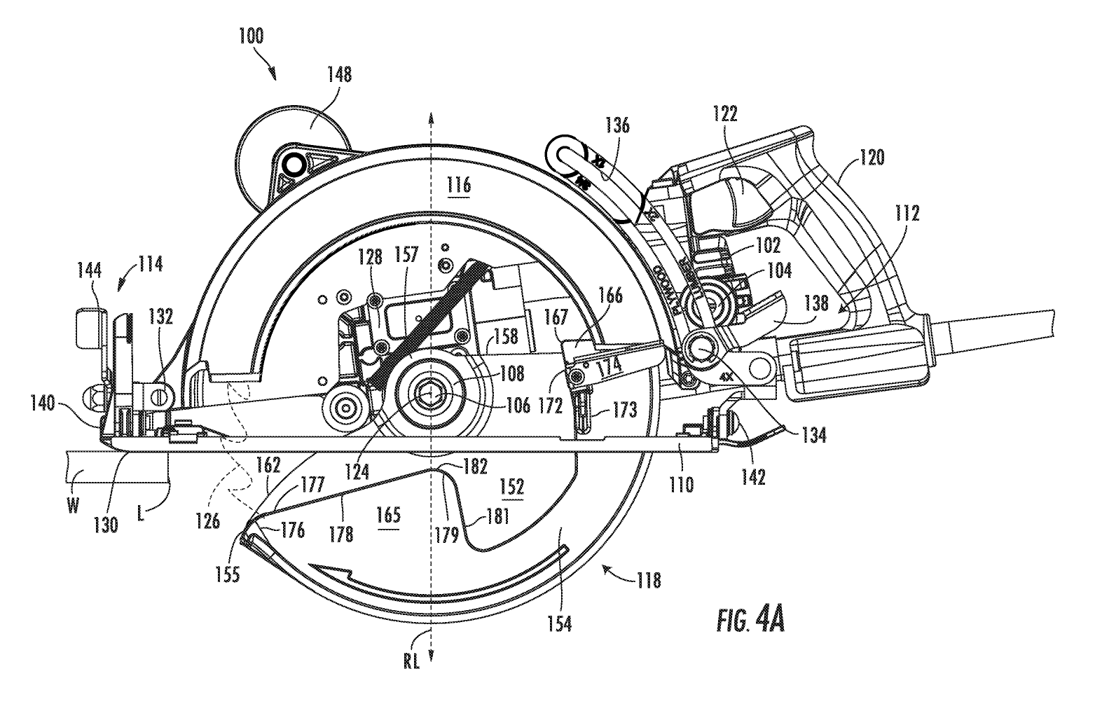

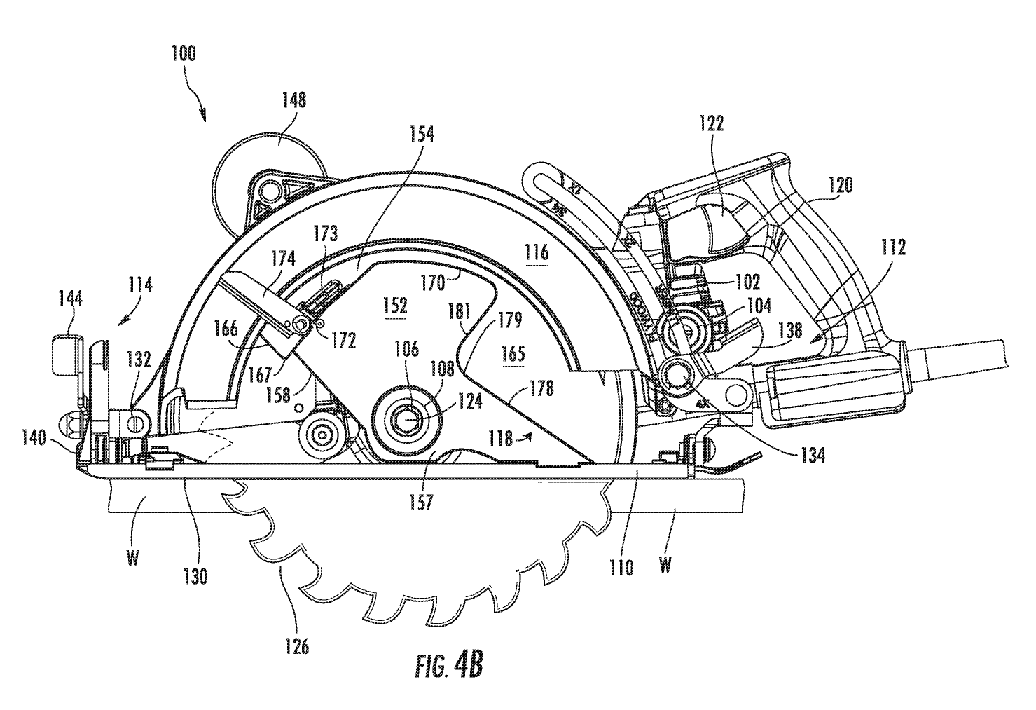

As shown in FIG. 3, a circular saw 100 includes a housing 102, a motor 104 (FIGS. 4A and 4B) supported by the housing 102, a blade axle 106, an arbor assembly 108, a footplate 110, a cutting depth adjustment mechanism 112, a bevel adjustment mechanism 114, an upper blade guard 116, and a lower blade guard 118. The circular saw 100 is shown in FIG. 3 as a 10¼″ worm drive circular saw. In other embodiments, the circular saw 100 is a 7¼″ worm drive circular saw, a 7¼″ standard drive circular saw, a 10¼ standard drive circular saw, or any other handheld and portable circular saw.

The housing 102 supports a rear handle 120 that includes a trigger switch 122 operably connected to the motor 104. In the exemplary embodiment of the FIG. 3, the housing 102 is formed from magnesium, such that housing 102 is very strong and lightweight.

The blade axle 106 is operably connected to the motor 104 and is configured for rotation relative to the housing 102. The blade axle 106 defines an axis of rotation 124 and is configured to support a saw blade 126, a portion of which is shown in broken lines in FIG. 3. The arbor assembly 108 is connected to the blade axle 106 and is configured to connect the saw blade 126 to the blade axle 106, such that the saw blade 126 rotates with the blade axle 106 about the axis of rotation 124 when the motor 104 is energized. In the illustrated embodiment, the circular saw 100 includes a gear housing 128 including a plurality of gears (not shown) operably connected to the motor 104 and the blade axle 106. The gear housing 128 is configured to reduce the rotational speed of an output (not shown) of the motor 104 to a speed that is suitable for rotating the saw blade 126. In an exemplary embodiment, the gear housing 128 includes a worm drive (not shown) for driving the blade axle 106; however, the circular saw 100 may include any type of gearing arrangement.

The footplate 110 is pivotally connected to the housing 102 and is configured to support the housing 102 and the motor 104 above a workpiece W (FIGS. 4A and 4B) during a cutting operation. The footplate 110 defines a workpiece support surface 130 that is configured to slide across the workpiece W during the cutting operation. In an exemplary embodiment, the footplate 110 is formed from magnesium, which is less prone to bending, warping, and twisting as compared to aluminum, steel, and other materials typically used to form the footplate of a circular saw.

With reference to FIG. 3, the bevel adjustment mechanism 114 is operably connected to the housing 102 and to the footplate 110 and is configured to fix the position of the housing 102 and the axis of rotation 124 relative to the footplate 110 at a selected bevel angle with respect to the workpiece support surface 130. The housing 102 is configured to pivot about the point 140 and the point 142 as the bevel angle is adjusted with the mechanism 114. A lever 144 locks the housing 102 and the axis of rotation 124 at the selected bevel angle. The bevel angle of the housing 102 and the axis of rotation 124 corresponds to a bevel angle of the saw blade 126. Thus, the bevel angle is measured between the saw blade 126 and a plane that is perpendicular to the workpiece support surface 130 of the footplate 110. When the saw blade 126 is perpendicular to the workpiece support surface 130 the bevel angle of the housing 102, the axis of rotation 124, and the saw blade 126 is zero degrees. As the housing 102 is pivoted in the direction 146 about the points 140, 142, the bevel angle of the housing 102, the axis of rotation 124, and the saw blade 126 is increased. The bevel adjustment mechanism 114 is configured to secure the housing 102, the axis of rotation 124, and the saw blade 126 at a bevel angle from zero degrees to at least sixty degrees. In FIGS. 3, 4A, and 4B, the circular saw 100 is shown in a reference position in which the footplate 110 supports the motor 104 above the workpiece W, and the bevel adjustment mechanism 114 secures the saw blade 126 with a zero degree bevel angle.

As shown in FIG. 4A, the cutting depth adjustment mechanism 112 is operably connected to the housing 102 and to the footplate 110 and is configured to fix the position of the housing 102 relative to the footplate 110 so that the saw blade 126 extends a desired distance below the workpiece support surface 130. The housing 102 is configured to pivot about the point 132 and a shaft 134 is configured to slide in a slot 136 as the cutting depth is adjusted with the mechanism 112. A lever 138 locks the cutting depth adjustment mechanism 112 at a selected cutting depth.

The upper blade guard 116 is supported by the housing 102 and is fixed in position relative to the housing 102. The upper blade guard 116 is configured to cover most of the upper half of the saw blade 126.

A front handle 148 (also shown in FIG. 3) extends from the upper blade guard 116 and is configured to be grasped by a user of the circular saw 100 during a cutting operation. In other embodiments, the circular saw 100 does not include the front handle 148.

With reference to FIGS. 4A and 4B, the lower blade guard 118 is rotatably mounted to the housing 102 of the circular saw 100. The lower blade guard 118 is configured for rotation about the axis of rotation 124 from a closed position (FIG. 4A) to an open position (FIG. 4B). The circular saw 100 includes a biasing member (not shown), such as a torsion spring, that is configured to bias the lower blade guard 118 toward the closed position.

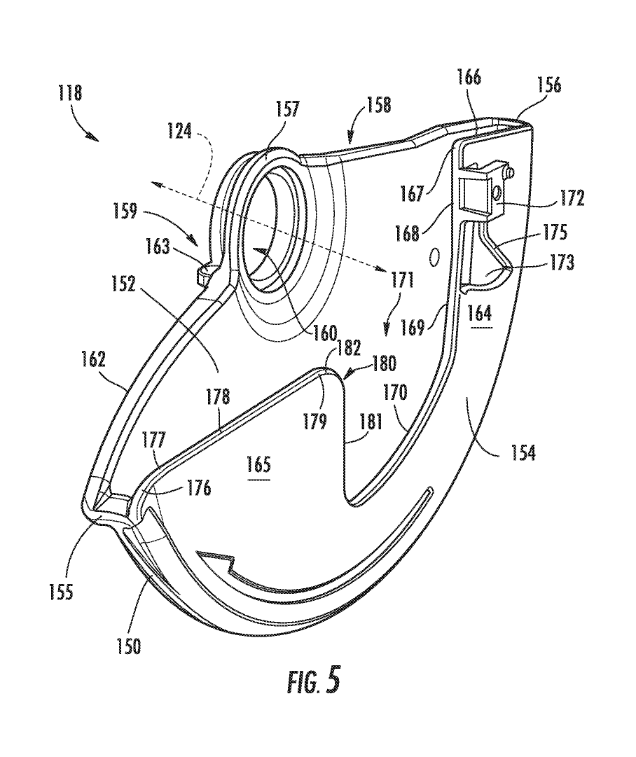

As shown in FIG. 5, the lower blade guard 118 includes a lower wall 150, and an inner side wall 152 and an outer side wall 154 extending from the lower wall 150. The lower wall 150 has a generally rounded profile and is conformed to the periphery of the saw blade 126, thereby protecting the saw blade 126 from damage and shielding the user from unintended contact with the saw blade 126. The lower wall 150 extends from a front edge portion 155 to a rear edge portion 156.

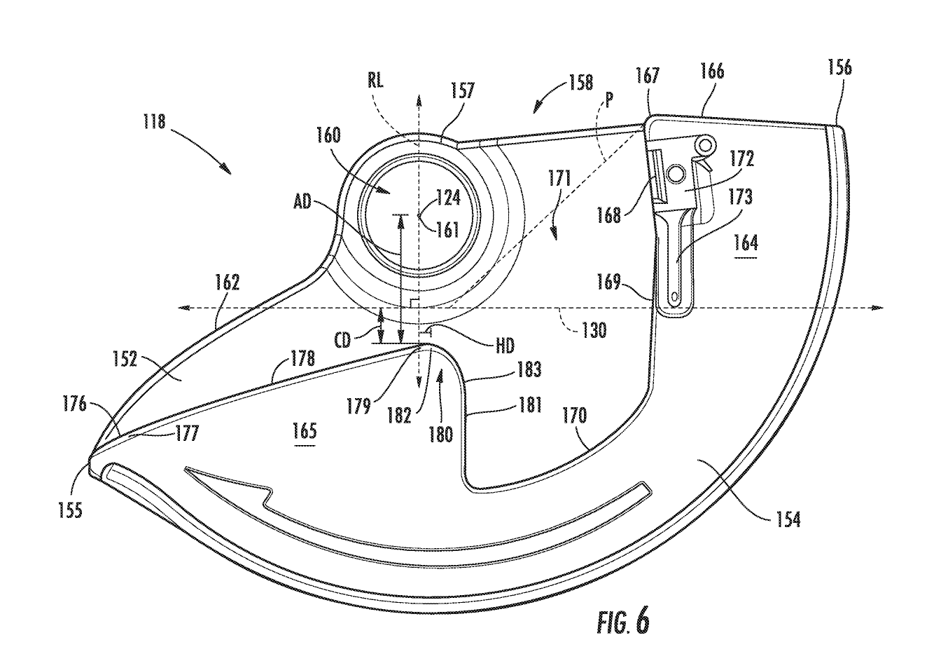

The inner side wall 152 includes a mounting ring 157, an upper edge 158, and a mounting structure 159. The mounting ring 157 defines a circular opening 160 through which the blade axle 106 (FIG. 3) extends. A center point 161 (FIG. 6) of the opening 160 is aligned with the axis of rotation 124. The lower blade guard 118 pivots from the closed position to the open position about the center point 161.

The upper edge 158 of the inner side wall 152 extends from the front edge portion 155 of the lower wall 150 to the rear edge portion 156 of the lower wall 150. A front portion 162 of the upper edge 158, extends from the front edge portion 155 to the mounting ring 157 and is configured to contact the workpiece W during most cutting operations with the circular saw 100. The front portion 162 is non-linear and is curved with a convex profile with reference to the inner side wall 152.

The mounting structure 159 extends from the mounting ring 157 and defines a flat surface 163 against which the biasing element biases the lower blade guard 118 toward the closed position.

With reference to FIG. 6, the outer side wall 154 includes a rear wall portion 164 and an anti-snag structure 165. The rear wall portion 164 has a generally horizontal edge 166 extending from the rear edge portion 156 to an upper corner 167. An angled edge 168 extends from the upper corner 167 to a generally vertical edge 169. The vertical edge 169 extends from the angled edge 168 to a curved edge 170. The curved edge 170 extends from the vertical edge 169 to the anti-snag structure 165. A pocket 171 is defined by the rear wall portion 164 and the anti-snag structure 165.

As shown in FIG. 6, the anti-snag structure 165 is generally triangular in shape and includes a leading curved edge 176, a front end portion 177, a linear leading edge 178, a trailing edge portion 179, a rounded corner 180, a corner end portion 183, and a linear trailing edge 181. The leading curved edge 176 extends from the front edge portion 155 of the lower wall 150 to the front end portion 177, which is located between the leading curved edge 176 and the linear leading edge 178. The leading curved edge 176 is configured to contact a workpiece W during most cutting operations with the circular saw 100. The front end portion 177 is a point of the anti-snag structure 165 that defines a boundary between the leading curved edge 176 and the linear leading edge 178.

The linear leading edge 178 is located between the front end portion 177 and the trailing edge portion 179. Unlike the front portion 162 of the upper edge 158 and unlike the curved leading edge 5 of the prior art blade guard 1, the linear leading edge 178 is linear, very nearly linear, or substantially linear. A very nearly linear edge and a substantially linear edge are as linear as machine tolerances typically allow. The trailing edge portion 179 is a point of the anti-snag structure 165 that defines a boundary between the linear leading edge 178 and the rounded corner 180. In the illustrated embodiment, the linear leading edge 178 is completely linear between the front end portion 177 and the trailing edge portion 179.

The lower blade guard 118 is configured such that when the circular saw 100 is in the reference position and the lower blade guard 118 is in the closed position, a reference line RL extending through the axis of rotation 124 and perpendicular to the footplate 110 when viewed from a side elevational view passes through the linear leading edge 178. In FIG. 6, the location of the workpiece support surface 130 of the footplate 110 is shown by the line 130.

The configuration of the linear leading edge 178 relative to the reference line RL configures the linear leading edge 178 to contact the workpiece W during certain cutting operations with the circular saw 100. For example, the linear leading edge 178 is configured to contact the workpiece W during cutting operations that have a high miter angle (greater than about forty degrees) and during combination cutting operations that a have a high miter angle (greater than about forty degrees) and a high bevel angle (greater than about forty degrees). These cutting operations are referred herein to as extreme angle cutting operations. As defined herein, the miter angle is measured between a plane extending perpendicularly from a leading side L (FIG. 4A) of the workpiece W and the saw blade 126. A miter angle of zero degrees occurs when the saw blade 126 is angled to the cut the workpiece W perpendicularly to the leading side L of the workpiece W. The miter angle increases as the saw blade 126 is rotated away from the plane that extends perpendicularly to the leading side L of the workpiece W.

As shown in FIG. 6, the rounded corner 180 is located between the trailing edge portion 179 and the corner end portion 183. The rounded corner 180 defines an apex 182, which is the point of the rounded corner 180 that is closest to the workpiece support surface 130 when the lower blade guard 118 is in the closed position. When the circular saw 100 is in the reference position and the lower blade guard 118 is in the closed position, the rounded corner 180 is located completely behind the reference line RL, such that the reference line RL intersects no portion of the rounded corner 180. The rounded corner 180 is a substantially circular corner defining a radius of about fifteen millimeters. In other embodiments, the radius of the corner 180 is from eight to twenty millimeters. A line P extending through the apex 182 and the upper corner 167 defines an upper boundary of the pocket 171. The corner end portion 183 is a point of the anti-snag structure 165 that defines a boundary between the rounded corner 180 and the linear trailing edge 181.

The reference line RL passes through the linear leading edge 178 at position that spaces the apex 182 apart from the reference line RL by a horizontal distance HD. The apex 182 is spaced apart from the axis of rotation 124 by an apex distance AD and is spaced apart from the workpiece support surface 130 by a corner distance CD. In the illustrated embodiment, the horizontal distance HD is about 2.4 millimeters, the apex distance AD is about 45.1 millimeters, and the corner distance CD is about 10.1 millimeters. In other embodiments, the horizontal distance HD is from zero millimeters to about twenty millimeters, the apex distance AD is from about twenty-five millimeters to about fifty-five millimeters, and the corner distance CD is from two millimeters to about twenty millimeters.

With reference to FIG. 5, the lower blade guard 118 also includes a grip attachment element 172 and a stop structure 173 extending from the rear wall portion 164. A lever 174 (FIG. 3) is attached to the grip attachment element 172 and is configured to be grasped during manual rotation of the lower blade guard 118. The stop structure 173 extends away from the rear wall portion 164 and defines an angled surface 175 configured to contact the footplate 110 such that the lower blade guard 118 rotates slightly toward the open position when the housing 102 is moved to a high bevel angle, such as greater than about forty degrees.

In operation, the configuration of the linear leading edge 178 and the position of the apex 182 at or below the workpiece support surface 130 and behind the reference line RL optimizes the lower blade guard 118 for extreme angle cutting operations. For example, in the illustrated embodiment, the configuration of the linear leading edge 178 and the apex 182 optimizes the lower blade guard 118 for a sixty degree bevel cut at any miter angle. In other embodiments, the configuration of the linear leading edge 178 optimizes the lower blade guard 118 for cutting operations having a bevel angle of thirty degrees to seventy degrees.

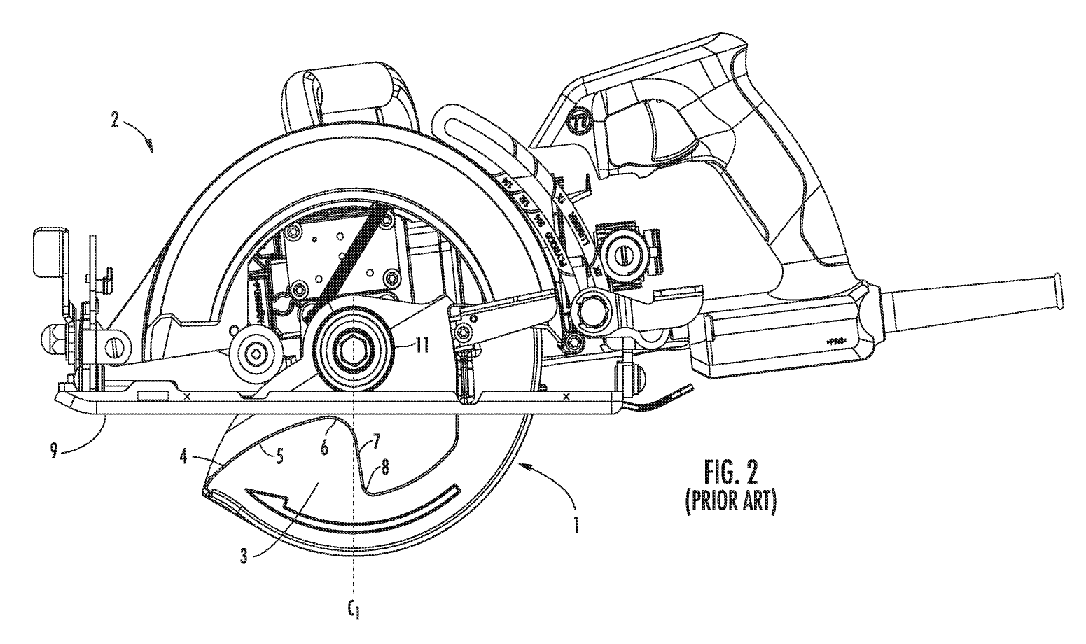

The configuration of the leading linear edge 178 and the apex 182 is also configured to prevent snagging of the workpiece W during a cutting operation. A snag occurs when a portion of a workpiece W enters the pocket 171 during a cutting operating and then contacts the angled edge 168, the vertical edge 169, or the curved edge 170, thereby preventing the lower blade guard 118 from rotating toward the open position in response to a force directed to advance the circular saw 100 through the workpiece W. The corner distance CD and the horizontal distance HD are selected to prevent any portion of the workpiece W from entering the pocket 171. This configuration prevents a vertical distance between the workpiece support surface 130 and the apex 182 from exceeding the corner distance CD as the lower blade guard 118 is pivoted from the closed position to the open position. Instead, the corner distance CD decreases during pivoting of the lower blade guard 118 from the closed position to the open position. Moreover, the reference line RL does not pass through the rounded corner 180 for any position of the lower blade guard 118. Therefore, the lower blade guard 118 is configured such that if a workpiece W is thick enough to contact the anti-snag structure 165, the workpiece W will not enter the pocket 171 during a cutting operation, because the distance between the anti-snag structure 165 and the workpiece support surface 130 decreases as the lower blade guard 118 is rotated toward the closed position. In the prior art (see FIG. 2), a corresponding vertical distance between the corner 6 and the footplate 9 increases as the lower blade guard 1 is rotated from the closed position to the open position. Accordingly, a workpiece W having certain thicknesses may pass between the corner 6 and the footplate 9 and then enter pocket, thereby snagging the circular saw 2 and requiring the user to manually rotate the lower blade guard 1 toward the open position.

The combination of the straight or nearly straight profile of leading linear edge 178 and the position the apex 182 at or below the workpiece support surface 130 and behind the reference line RL yields several additional benefits over known circular saws. First, the configuration ensures that when cutting narrow sections of thin material (e.g., ¼″ or ½″ thick workpieces, such as sheet material) at a zero bevel angle, the material comes in contact with the anti-snag structure 165, and does not bypass the outer side wall 154, thereby ensuring that the lower blade guard 118 does not snag during such cuts. Second, the configuration allows a user to make a combination cut requiring a high bevel angle (forty-five degrees and above) and a high miter angle (forty-five degrees and above), without snagging. During such a combination cut, the workpiece W either does not contact the outer side wall 154 or contacts the linear leading edge 178, such that when the circular saw 100 is advanced in a forward direction to cut the workpiece W, a moment formed from the contact of the workpiece W with the lower blade guard 118 that resists against rotation of the lower blade guard 118 to the open position is minimized, and the lower blade guard 118 thus properly rotates to the open position as the saw 100 is advanced through the workpiece W. Therefore, lower blade guard 118 opens with relative ease during combination cuts and eliminates the need for the user to manually open the guard 118 with the lever 174.

The circular saw 100 is distinguished from other types of power saws, such as miter saws, because the motor 104 is located on an opposite side of the footplate 110 from the workpiece support surface 130. Also, the circular saw 100 is handheld during operation and is supportable by only the workpiece W. Whereas, a miter saw includes a motor on the same side of a base as a workpiece support surface, is not handheld during operation, and requires a support surface to support the saw during operation.

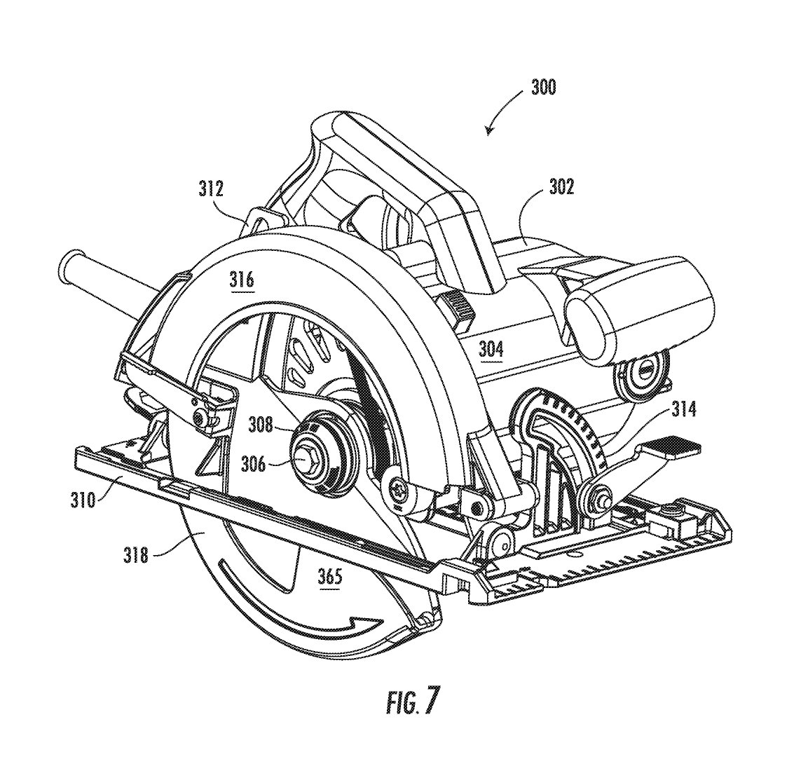

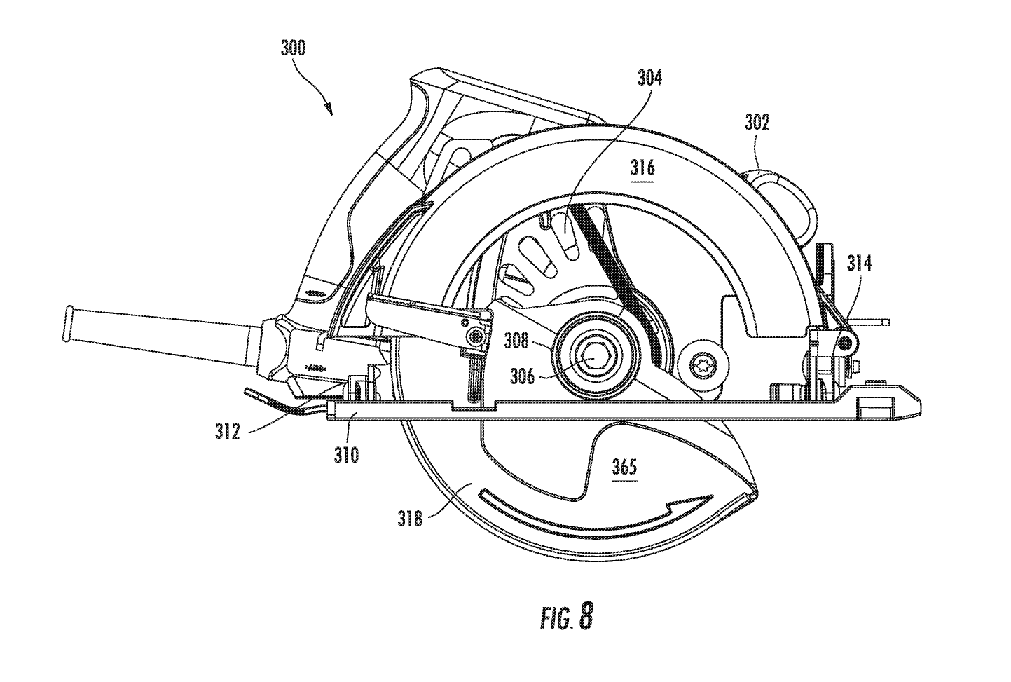

As shown in FIGS. 7 and 8, a circular saw 300 includes a housing 302, a motor 304 supported by the housing 302, a blade axle 306, an arbor assembly 308, a footplate 310, a cutting depth adjustment mechanism 312, a bevel adjustment mechanism 314, an upper blade guard 316, and a lower blade guard 318. The circular saw 300 is shown as a 7¼″ standard drive circular saw. The lower blade guard 318 includes an anti-snag structure 365 that is configured exactly the same as the anti-snag structure 165 of the lower blade guard 118.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A circular saw comprising:
a motor;
a blade axle operably connected to the motor and configured to support a circular saw blade, the blade axle defining an axis of rotation;
a footplate configured to support the motor above a workpiece at a reference position, the blade positioned with zero bevel angle relative to the workpiece when the motor is in the reference position; and
a blade guard rotatable about the axis of rotation from a closed position to an open position, the blade guard including an anti-snag structure with a front end portion and a trailing edge portion, the anti-snag structure including a linear leading edge located between the front end portion and the trailing edge portion, the anti-snag structure configured such that when the footplate is at the reference position and the blade guard is in the closed position, a line extending through the axis of rotation and perpendicular to the footplate when viewed from a side elevational view passes through the linear leading edge.

2. The circular saw of claim 1, wherein the anti-snag structure further comprises:
a corner end portion;
a rounded corner extending from the trailing edge portion to the corner end portion; and
a linear trailing edge extending away from the corner end portion.

3. The circular saw of claim 2, wherein when the footplate is in the reference position, the line does not pass through the rounded corner for any position of the blade guard.

4. The circular saw of claim 2, wherein:
the rounded corner defines an apex that is spaced apart from the footplate by a corner distance when the footplate is in the reference position and the blade guard is in the closed position, and
a distance from the apex to the footplate does not exceed the corner distance when the footplate in the reference position and as the blade guard is pivoted from the closed position to the open position.

5. The circular saw of claim 4, wherein the corner distance is from 1.7 mm to 10.1 mm.

6. The circular saw of claim 4, wherein when the footplate is in the reference position a vertical distance from the axis of rotation to the apex is from 32.7 mm to 45.1 mm.

7. The circular saw of claim 2, wherein:
the rounded corner defines an apex as a point of the rounded corner that is closest to the footplate when the footplate is in the reference position and the blade guard is in the closed position, and
the apex is spaced apart from the line by a horizontal distance.

8. The circular saw of claim 7, wherein the horizontal distance is from 0.1 millimeters to 20.0 millimeters.

9. The circular saw of claim 1, wherein:
the blade guard further includes a leading curved edge, and
the front end portion is located between the leading curved edge and the linear leading edge.

10. A circular saw comprising:
a housing;
a motor supported by the housing;
a blade axle operably connected to the motor and configured to support a circular saw blade, the blade axle defining an axis of rotation;
a footplate configured to support the housing and defining a workpiece support surface, the footplate positionable relative to housing in a reference position in which the blade defines zero bevel angle relative to the workpiece support surface; and
a blade guard rotatable about the axis of rotation from a closed position to an open position, the blade guard including an anti-snag structure with a front end portion and a trailing edge portion, the anti-snag structure including a linear leading edge located between the front end portion and the trailing edge portion, the anti-snag structure configured such that when the footplate is at the reference position and the blade guard is in the closed position, a line extending through the axis of rotation and perpendicular to the footplate when viewed from a side elevational view passes through the linear leading edge.

11. The circular saw of claim 10, wherein the anti-snag structure further comprises:
a corner end portion;
a rounded corner extending from the trailing edge portion to the corner end portion; and
a linear trailing edge extending away from the corner end portion.

12. The circular saw of claim 11, wherein when the footplate is in the reference position, the line does not pass through the rounded corner for any position of the blade guard.

13. The circular saw of claim 11, wherein:
the rounded corner defines an apex that is spaced apart from the footplate by a corner distance when the footplate is in the reference position and the blade guard is in the closed position, and
a distance from the apex to the footplate does not exceed the corner distance when the footplate in the reference position and as the blade guard is pivoted from the closed position to the open position.

14. The circular saw of claim 13, wherein the corner distance is from 1.7 mm to 10.1 mm.

15. The circular saw of claim 13, wherein when the footplate is in the reference position a vertical distance from the axis of rotation to the apex is from 32.7 mm to 45.1 mm.

16. The circular saw of claim 11, wherein:
the rounded corner defines an apex as a point of the rounded corner that is closest to the footplate when the footplate is in the reference position and the blade guard is in the closed position, and
the apex is spaced apart from the line by a horizontal distance.

17. The circular saw of claim 16, wherein the horizontal distance is from 0.1 millimeters to 20.0 millimeters.

18. The circular saw of claim 10, wherein:
the blade guard further includes a leading curved edge, and
the front end portion is located between the leading curved edge and the linear leading edge.
